(19) United States
(12) Patent Application Publication
(10) Pub. No.: US 2025/0172973 A1
(43) Pub. Date: May 29, 2025

(54) DISPLAY DEVICE

(71) Applicant: Samsung Display Co., LTD., Yongin-si (KR)

(72) Inventors: KYEOMRYONG KIM, Yongin-si (KR); JAE-BUM HAN, Yongin-si (KR); YEWON KWON, Yongin-si (KR); KI-CHUNG CHOI, Yongin-si (KR)

(21) Appl. No.: 18/772,496

(22) Filed: Jul. 15, 2024

(30) Foreign Application Priority Data
Nov. 27, 2023 (KR) 10-2023-0166294

(51) Int. Cl. G06F 1/16

(52) U.S. Cl. CPC G06F 1/1656; G06F 1/1616; G06F 1/1652

(57) ABSTRACT

A display device is divided into a deformable part which is foldable or rollable and a non-deformable part disposed adjacent to the deformable part. The display device may include a support layer containing a polymer resin, a lower conductive layer disposed on the support layer and having a first metal layer, a second metal layer, and a third metal layer stacked in sequence, and a display panel disposed on the lower conductive layer. The first metal layer may contain nickel (Ni) and vanadium (V), the second metal layer may contain silver (Ag), and the third metal layer may contain nickel (Ni).

This application claims priority to Korean Patent Application No. 10-2023-0166294, filed on Nov. 27, 2023, and all the benefits accruing therefrom under 35 U.S.C. § 119, the content of which in its entirety is herein incorporated by reference.

### BACKGROUND

### 1. Field

The invention relates to a display device, and more particularly to a display device which is capable of folding or rolling.

### 2. Description of Related Art

Various display devices, such as a television, a mobile phone, a tablet computer, and a game console, are being developed. Recently, flexible display devices including flexible display panels capable of sliding or folding are being developed. The flexible display device, unlike a rigid display device, may be foldable or bendable. The flexible display device, the shape of which is variously deformable, may be portable regardless of the existing screen size, thereby improving a user's convenience.

### SUMMARY

The invention provides a display device exhibiting excellent reliability in a high temperature and high humidity environment.

According to an embodiment, the invention provides a display device divided into a deformable part which is foldable or rollable and a non-deformable part disposed adjacent to the deformable part, the display device including a support layer containing a polymer resin, a lower conductive layer disposed on the support layer and having a first metal layer, a second metal layer, and a third metal layer stacked in sequence, and a display panel disposed on the lower conductive layer, wherein the first metal layer contains nickel (Ni) and vanadium (V), the second metal layer contains silver (Ag), and the third metal layer contains nickel (Ni).

In an embodiment, the first metal layer may be directly disposed on the support layer.

In an embodiment, a content of the vanadium may be about 1 at % to about 10 at % on the basis of about 100 at % of an atomic content of the first metal layer.

In an embodiment, the first metal layer may further include at least one of niobium (Nb), tantalum (Ta), or dubnium (Db).

In an embodiment, the lower conductive layer may have an average surface roughness of about 1500 nm to about 3000 nm.

In an embodiment, the first metal layer may have a thickness of about 60 nm to about 120 nm.

In an embodiment, the third metal layer may further include vanadium.

In an embodiment, the third metal layer may have a thickness of about 60 nm to about 120 nm.

In an embodiment, the third metal layer may further include at least one of niobium (Nb), tantalum (Ta), or dubnium (Db).

In an embodiment, the support layer may include any one among carbon fiber reinforced plastic (CFRP), glass fiber reinforced plastic (GFRP), and aramid fiber reinforced plastic (AFRP).

In an embodiment, a thickness of the second metal layer may be larger than a thickness of the first metal layer and a thickness of the third metal layer.

In an embodiment, the second metal layer may be directly disposed between the first metal layer and the third metal layer.

In an embodiment, a display device, divided into a deformable part which is foldable or rollable and a non-deformable part disposed adjacent to the deformable part is provided, where the display device includes a support layer containing a polymer resin, a lower conductive layer disposed on the support layer and having a first metal layer, a second metal layer, and a third metal layer stacked in sequence, and a display panel disposed on the lower conductive layer, where each of the first metal layer and the third metal layer contains nickel (Ni) and vanadium (V), where a content of the vanadium is about 1 at % to about 10 at % on the basis of about 100 at % of an atomic content of each of the first metal layer and the third metal layer.

In an embodiment, the second metal layer may include silver (Ag).

In an embodiment, a thickness of the second metal layer may be larger than a thickness of the first metal layer and a thickness of the third metal layer.

In an embodiment, each of the first metal layer and the third metal layer may further include at least one of niobium (Nb), tantalum (Ta), or dubnium (Db).

In an embodiment, the lower conductive layer may have an average surface roughness of about 1500 nm to about 3000 nm.

In an embodiment, each of the first metal layer and the third metal layer may have a thickness of about 60 nm to about 120 nm.

In an embodiment, the first metal layer may be directly disposed on the support layer.

In an embodiment, the support layer may include any one among carbon fiber reinforced plastic (CFRP), glass fiber reinforced plastic (GFRP), and aramid fiber reinforced plastic (AFRP).

### BRIEF DESCRIPTION OF THE FIGURES

The accompanying drawings are included to provide a further understanding of the invention, and are incorporated in and constitute a part of this specification. The drawings illustrate embodiments of the invention and, together with the description, serve to explain principles of the invention. In the drawings:

FIG. 1A is a perspective view of a display device, according to an embodiment;

FIG. 1B is a perspective view of a display device, according to an embodiment;

FIG. 1C is a plan view of a display device, according to an embodiment;

FIG. 1D is a perspective view of a display device, according to an embodiment;

FIG. 2A is a perspective view of a display device, according to an embodiment;

FIG. 2B is a perspective view of a display device, according to an embodiment;

FIG. 3 is an exploded perspective view of a display device, according to an embodiment;

FIG. 4 is a cross-sectional view illustrating a portion of the display device corresponding to line I-I′ of FIG. 3, according to an embodiment;

FIG. 5 is an enlarged cross-sectional view illustrating region AA′ of FIG. 4, according to an embodiment;

FIG. 6A is an image showing a portion of a display device, according to a Comparative Example;

FIG. 6B is an image showing a portion of a display device according to an Example, according to an embodiment; and

FIG. 7 is a cross-sectional view illustrating a portion of a display device, according to an embodiment.

### DETAILED DESCRIPTION

Embodiments of the invention will be described below in more detail with reference to the accompanying drawings. The invention may, however, be embodied in different forms and should not be construed as limited to the embodiments set forth herein. Rather, these embodiments are provided so that this disclosure will be thorough and complete, and will fully convey the scope of the invention to those skilled in the art.

In this specification, it will be understood that when an element (or a region, a layer, a portion, or the like) is referred to as being “on”, “connected to” or “coupled to” another element, it may be directly disposed on, connected or coupled to the other element, or intervening elements may be disposed therebetween.

Like reference numerals or symbols refer to like elements throughout. In the drawings, the thickness, the ratio, and the size of the element are exaggerated for effective description of the technical contents. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the scope of the inventive concept. Similarly, a second element, component, region, layer or section may be termed a first element, component, region, layer or section. As used herein, the singular forms, “a”, “an” and “the” are intended to include the plural forms as well, unless the context clearly indicates otherwise.

Also, terms of “below”, “on lower side”, “above”, “on upper side”, or the like may be used to describe the relationships of the elements illustrated in the drawings. These terms have relative concepts and are described on the basis of the directions indicated in the drawings.

It will be further understood that the terms “includes” and/or “have”, when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

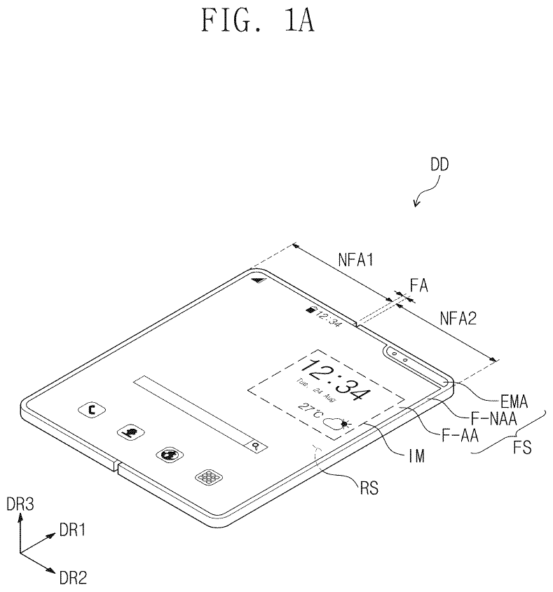

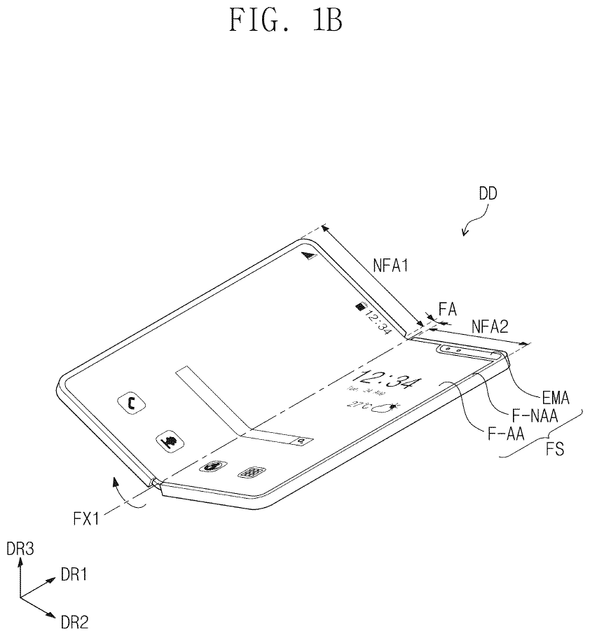

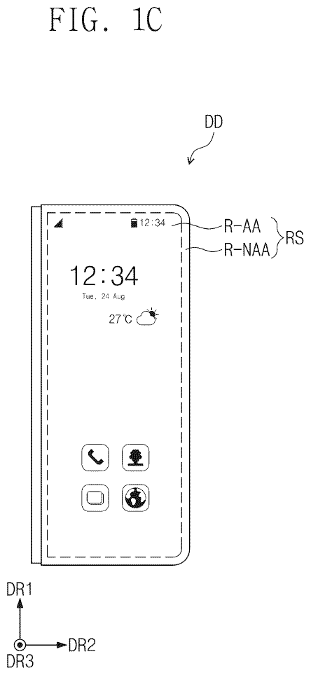

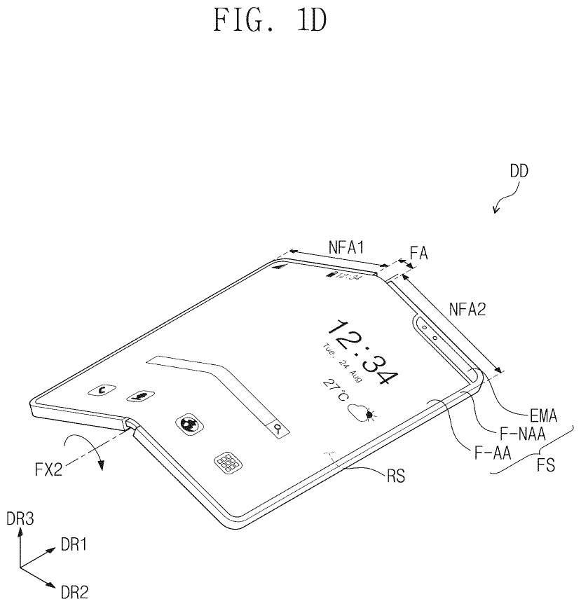

Hereinafter, a display device according to an embodiment will be described with reference to the accompanying drawings. FIG. 1A is a perspective view of an unfolded display device DD, according to an embodiment.

The display device DD, according to an embodiment, may be activated in response to electrical signals. For example, the display device DD may be a mobile phone, a tablet computer, a car navigation, a game console, or a wearable device, but the invention is not limited thereto. FIG. 1A exemplarily illustrates an embodiment where the display device DD is a mobile phone.

In an embodiment, the display device DD may include a first display surface FS defined by a first directional axis DR1 and a second directional axis DR2 crossing the first directional axis DR1. The display device DD may provide an image IM to a user through the first display surface FS. The display device DD may display the image IM on the first display surface FS that is directed parallel to each of the first directional axis DR1 and the second directional axis DR2 toward a third directional axis DR3.

In this specification, the first directional axis DR1 and the second directional axis DR2 may cross at right angles, and the third directional axis DR3 may be the normal direction of a plane defined by the first directional axis DR1 and the second directional axis DR2. In an embodiment, the thickness direction of the display device DD may be a direction that is parallel to the third directional axis DR3. A front surface (or upper surface) and a rear surface (or lower surface) may be opposed to each other in the third directional axis DR3, and the normal direction of each of the front surface (or upper surface) and the rear surface (lower surface) may be parallel to the third directional axis DR3. The front surface (or upper surface) refers to a surface close to the first display surface FS, and the rear surface (or lower surface) refers to a surface spaced apart from the first display surface FS. In addition, the rear surface (or lower surface) refers to a surface close to a second display surface RS to be described later. An upper side (or upper part) refers to a direction approaching the first display surface FS, and a lower side (or lower part) refers to a direction away from the first display surface FS.

A cross-section refers to a surface that is parallel to the thickness direction DR3, and a plane refers to a plane that is perpendicular to the thickness direction DR3. The plane refers to a plane defined by the first directional axis DR1 and the second directional axis DR2.

Directions indicated by the first to third directional axes DR1, DR2, and DR3, described in this specification, may be relative concepts and may thus be changed to other directions. In addition, the directions indicated by the first to third directional axes DR1, DR2, and DR3 may be described as first to third directions, and denoted as the same reference symbols or numbers.

In an embodiment, the display device DD may detect an external input applied from the outside. The external input may include various forms of inputs provided from the outside of the display device DD. For example, the external input may include not only an external input applied by contact with a part of a user's body such as a hand, but also an external input applied in close proximity to the display device DD, or applied adjacent to the display device DD at a predetermined distance (for example, hovering). In addition, the external input may have various forms such as power, pressure, temperature, and light.

In an embodiment, the display device DD may include the first display surface FS and the second display surface RS. The first display surface FS may include a first active region F-AA, a first peripheral region F-NAA, and an electronic module region EMA. The second display surface RS may be defined as a surface opposed to at least a portion of the first display surface FS. That is, the second display surface RS may be defined as a portion of the rear surface of the display device DD.

In an embodiment, the first active region F-AA may be activated in response to electrical signals. The first active region F-AA may be a region where the image IM is displayed, and various forms of external inputs are detected.

In an embodiment, the first peripheral region F-NAA may be disposed adjacent to the first active region F-AA. The first peripheral region F-NAA may have a predetermined color. The first peripheral region F-NAA may surround the first active region F-AA. Accordingly, the shape of the first active region F-AA may be defined substantially by the first peripheral region F-NAA. However, this is an example, and in another embodiment, the first peripheral region F-NAA may also be disposed adjacent only to one side of the first active region F-AA, or may also be omitted.

In an embodiment, various electronic modules may be disposed in the electronic module region EMA. For example, the electronic module may include at least any one of a camera, a speaker, a light-detecting sensor, or a heat-detecting sensor. The electronic module region EMA may detect an external subject received through the display surfaces FS and RS, or provide a sound signal, such as a voice, to the outside through the display surfaces FS and RS. The electronic module may also include a plurality of components, and is not limited to any one embodiment of the invention.

In an embodiment, the electronic module region EMA may be surrounded by the first peripheral region F-NAA. However, this is an example, and is not limited to an one embodiment. For example, in another embodiment, the electronic module region EMA may be surrounded by the first active region F-AA and the first peripheral region F-NAA, and the electronic module region EMA may be disposed in the first active region F-AA.

In an embodiment, the display device DD may be a flexible device. The display device DD, according to an embodiment, may be divided into a deformable part which is foldable or rollable, and a non-deformable part disposed adjacent to the deformable part. FIG. 1A illustrates that the display device DD includes a folding region FA which is foldable, and non-folding regions NFA1 and NFA2 disposed adjacent to the folding region. The folding region FA may correspond to the deformable part which is foldable, and the non-folding regions NFA1 and NFA2 may correspond to the non-deformable part.

In an embodiment, the non-folding regions NFA1 and NFA2 may extend from the folding region FA. For example, a first non-folding region NFA1, the folding region FA, and a second non-folding region NFA2 may be defined along the second direction DR2. The display device DD may be divided into the first non-folding region NFA1 and the second non-folding region NFA2 spaced apart from each other in the second direction DR2 with the folding region FA therebetween. For example, the first non-folding region NFA1 may be disposed on one side of the folding region FA in the second direction DR2, and the second non-folding region NFA2 may be disposed on the other side of the folding region FA in the second direction DR2.

FIG. 1A, etc. illustrates an embodiment of the display device DD including one folding region FA, but the invention is not limited thereto, and a plurality of folding regions may be defined in the display device DD. For example, the display device, according to an embodiment, may include at least two folding regions, and in addition, the display device may include at least three non-folding regions disposed with each of the folding regions therebetween.

FIGS. 1B and 1D are perspective views illustrating folding operation of a display device DD, according to an embodiment. FIG. 1C is a plan view of a folded display device DD, according to an embodiment.

FIG. 1B is a perspective view illustrating in-folding operation of a display device DD. In an embodiment and referring to FIG. 1B, the display device DD may be folded with respect to a first folding axis FX1 extending in a first direction DR1. When the display device DD is folded, a folding region FA may have a predetermined curvature and radius of curvature. The display device DD may be folded with respect to the first folding axis FX1 to be deformed into an in-folding state such that a first non-folding region NFA1 and a second non-folding region NFA2 face each other, and a first display surface FS is not exposed to the outside.

In an embodiment and referring to FIG. 1C, when the display device DD is in-folded, a second display surface RS may be viewed to a user. At this time, the second display surface RS may include a second active region R-AA that displays an image. The second active region R-AA may be activated in response to electrical signals. The second active region R-AA may be a region where the image is displayed, and various forms of external inputs are detected.

In an embodiment, the second display surface RS may include a second peripheral region R-NAA. The second peripheral region R-NAA may be disposed adjacent to the second active region R-AA. The second peripheral region R-NAA may have a predetermined color. The second peripheral region R-NAA may surround the second active region R-AA. In addition, although not illustrated in the drawing, the display device DD may further include an electronic module region, also in the second display surface RS, where an electronic module having various components is disposed, and is not limited to any one embodiment.

FIG. 1D is a perspective view illustrating out-folding operation of a display device DD, according to an embodiment. Referring to FIG. 1D, the display device DD, according to an embodiment, may be folded with respect to a second folding axis FX2 extending in a first direction DR1. The display device DD may be folded with respect to the second folding axis FX2 to be deformed into an out-folding state such that a first display surface FS is exposed to the outside. The display device DD may be provided to repeat in-folding or out-folding operation and unfolding operation, but the invention is not limited thereto.

According to an embodiment, FIGS. 1A to 1D exemplarily illustrate that the display device DD is folded with respect to one folding axis FX1 or FX2, but the number of folding axes, and accordingly, the number of non-folding regions, are not limited thereto. For example, the display device DD may be folded with respect to a plurality of folding axes such that respective portions of the first display surface FS and the second display surface RS face each other. In addition, it is illustrated that the first and second folding axes FX1 and FX2 are directed parallel to a long side of the display device DD, but the invention is not limited thereto, and the first and second folding axes FX1 and FX2 may be directed parallel to a short side of the display device DD.

In an embodiment, when the display device DD is in a folded state as illustrated in FIG. 1C, the first non-folding region NFA1 and the second non-folding region NFA2 may be defined as portions having display surfaces FS and RS directed parallel to a plane defined by the first directional axis DR1 and the second directional axis DR2, and the folding region FA may be defined as a region disposed between the first non-folding region NFA1 and the second non-folding region NFA2. The folding region FA may include a curved surface part which is bent to have a predetermined curvature in the folded state.

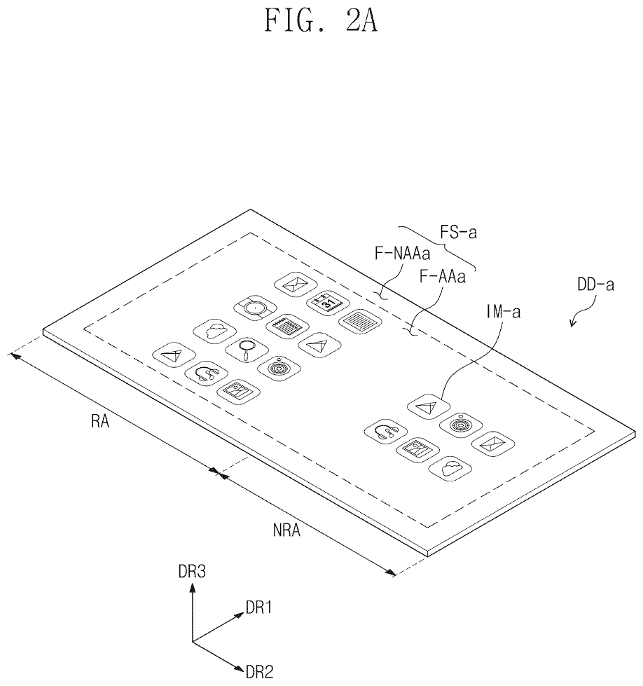

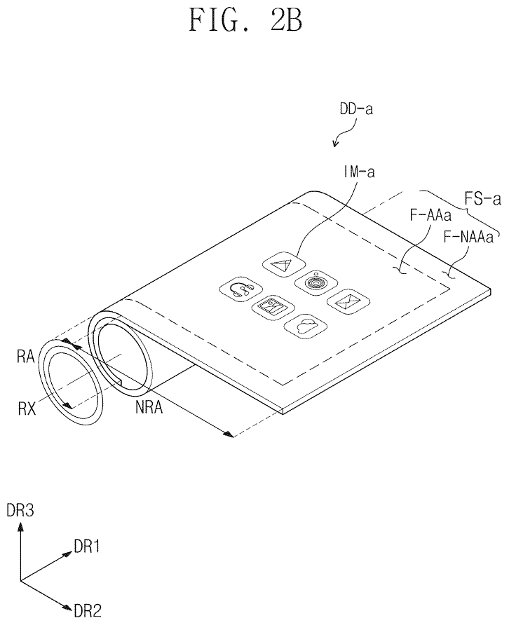

FIG. 2A is a perspective view of a display device DD-a, according to another embodiment, illustrating an unfolded state of the display device DD-a. FIG. 2B is a perspective view of the display device DD-a, illustrated in FIG. 2A, in a rolled state, according to an embodiment.

In an embodiment and referring to FIG. 2A, the display device DD-a may include a display surface FS-a defined by a first directional axis DR1 and a second directional axis DR2 crossing the first directional axis DR1. The display device DD-a may provide an image IM-a to a user through the display surface FS-a. The display device DD-a may display the image IM-a toward a third direction DR3.

In an embodiment, the display surface FS-a may include an active region F-AAa and a peripheral region F-NAAa. The active region F-AAa may be activated in response to electrical signals. The active region F-AAa may be a region where the image IM-a is displayed, and various forms of external inputs are detected.

In an embodiment, the peripheral region F-NAAa may be disposed adjacent to the active region F-AAa. The peripheral region F-NAAa may have a predetermined color. The peripheral region F-NAAa may surround the active region F-AAa. However, this is an example, and in another embodiment, the peripheral region F-NAAa may be disposed adjacent only to one side of the active region F-AAa, or may also be omitted.

In an embodiment, the display device DD-a may be divided into a deformable part which is foldable or rollable, and a non-deformable part disposed adjacent to the deformable part. FIG. 2A illustrates that the display device DD-a includes a rolling region RA which is rollable, and a non-rolling region NRA disposed adjacent to the rolling region. The rolling region RA may correspond to the deformable part which is rollable, and the non-rolling region NRA may correspond to the non-deformable part.

In another embodiment, unlike what is illustrated in the drawing, the active region F-AAa may not overlap the non-rolling region NRA. The active region F-AAa, where the image IM-a is displayed, may overlap only the rolling region RA. When the display device DD-a is rolled, only the peripheral region F-NAAa may be viewed to a user.

In an embodiment and referring to FIG. 2B, the rolling region RA may be rolled with respect to a rolling axis RX extending along a first direction DR1. FIG. 2B illustrates that the rolling axis RX is parallel to a short side of the display device DD-a, but the invention is not limited thereto. In another embodiment, the rolling axis RX may be directed parallel to a long side of the display device DD-a.

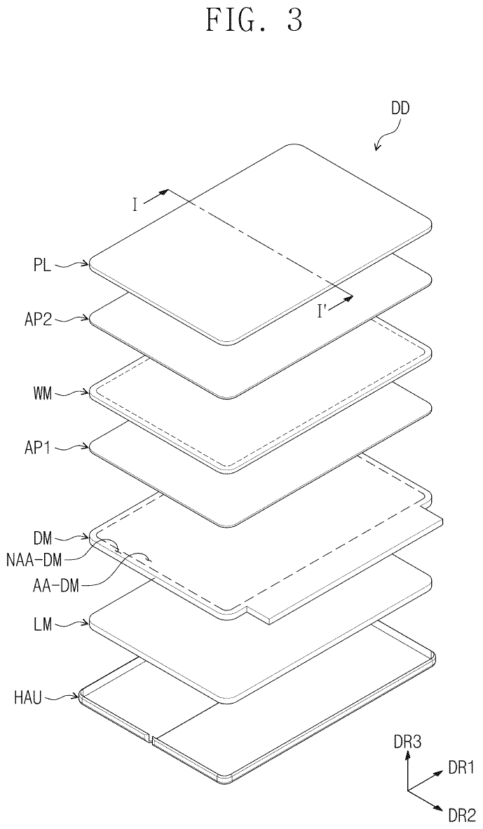

FIG. 3 is an exploded perspective view of the display device DD illustrated in FIG. 1A. In an embodiment and referring to FIG. 3, the display device DD may include a lower module LM, a display module DM disposed on the lower module LM, and a window WM disposed on the display module DM. In addition, the display device DD may further include a housing HAU and a protection layer PL. Hereinafter, description on the display device DD may also be equally applied to the display device DD-a illustrated in FIG. 2A.

In an embodiment, the housing HAU may include a material having a relatively high rigidity. For example, the housing HAU may include a plurality of frames and/or plates composed of glass, plastic, or metal. The housing HAU may provide a predetermined accommodating space. The display module DM may be accommodated in the accommodating space, and may thus be protected from external impact.

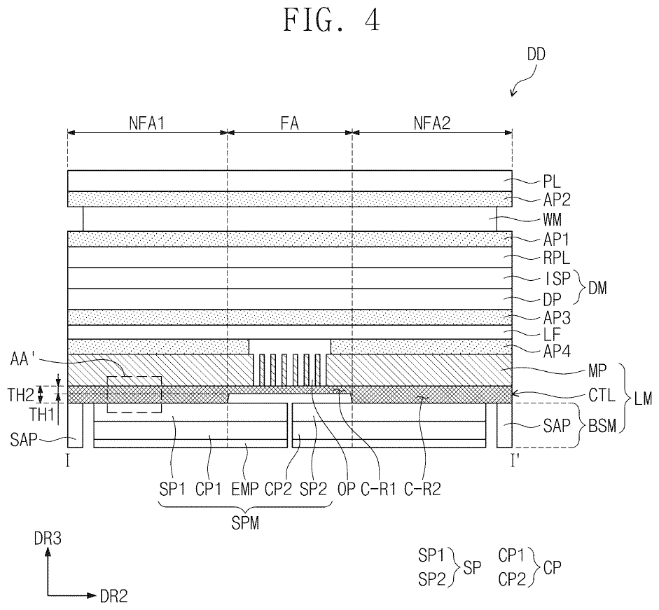

In an embodiment, the lower module LM may include a support layer SP (see FIG. 4) and a lower conductive layer CTL (see FIG. 4) to be described later. The lower module LM will be described in more detail later.

In an embodiment, the display module DM may be a component that generates an image and detects an input applied from the outside. A display region AA-DM and a non-display region NAA-DM may be defined in the display module DM. The display region AA-DM may correspond to the first active region F-AA illustrated in FIG. 1A, and the non-display region NAA-DM may correspond to the first peripheral region F-NAA illustrated in FIG. 1A.

In an embodiment, the display region AA-DM may be activated in response to electrical signals. The non-display region NAA-DM may be a region positioned adjacent to at least one side of the display region AA-DM. The non-display region NAA-DM may be disposed to surround the display region AA-DM. However, the invention is not limited thereto, and unlike what is illustrated in the drawing, in another embodiment, a portion of the non-display region NAA-DM may be omitted. A driving circuit, driving lines, or the like for driving the display region AA-DM may be disposed in the non-display region NAA-DM.

In an embodiment, the image IM (see FIG. 1A), generated from the display module DM, may pass through the window WM to be provided to a user. The window WM may include an optically transparent insulating material. The window WM may include a polymer substrate or a glass substrate. The window WM may be made of polyimide, polyacrylate, polymethylmethacrylate, polycarbonate, polyethylenenaphthalate, polyvinylidene chloride, polyvinylidene difluoride, polystyrene, ethylene vinyl-alcohol copolymer, or a combination thereof. However, this is an example, and the material included in the window WM is not limited thereto. For example, in another embodiment, the window WM may be a reinforced glass substrate that has been reinforced. The window WM may include ultra-thin glass (UTG).

In an embodiment, the protection layer PL may be a functional layer that protects one surface of the window WM. The protection layer PL may include a polymer film. The protection layer PL may include an anti-fingerprint-coating material, a hard-coating material, an anti-static material, etc.

In an embodiment, the display device DD may include a first adhesive layer AP1 disposed between the display module DM and the window WM, and a second adhesive layer AP2 disposed between the window WM and the protection layer PL. The window WM and the protection layer PL may be bonded to each other by the second adhesive layer AP2. The first adhesive layer AP1 and the second adhesive layer AP2 may each include a general adhesive or a gluing agent. For example, the first adhesive layer AP1 and the second adhesive layer AP2 may each include a general adhesive such as a pressure sensitive adhesive (PSA), an optically clear adhesive (OCA), and an optical clear resin (OCR), and the type is not limited to any one embodiment. Unlike what is illustrated in the drawing, in another embodiment, at least one of the first adhesive layer AP1 or the second adhesive layer AP2 may be omitted.

FIG. 4 is a cross-sectional view illustrating a portion corresponding to line I-I′ of FIG. 3, according to an embodiment. FIG. 4 is a cross-sectional view illustrating a display device DD, according to an embodiment.

In an embodiment and referring to FIG. 4, the display device DD may further include an optical layer RPL and a lower film LF. The optical layer RPL may be disposed between the display module DM and the window WM. The lower film LF may be disposed between the display module DM and the lower module LM.

In an embodiment, the optical layer RPL may be disposed on a display panel DP included in the display module DM. The optical layer RPL may control reflected light of external light on the display panel DP. The optical layer RPL may include, for example, a polarizing layer, or include a color filter layer. Meanwhile, unlike what is illustrated in the drawing, in another embodiment, the optical layer RPL may be omitted.

In an embodiment, the lower film LF may be disposed under the display panel DP. The lower film LF may protect a lower part of the display panel DP. The lower film LF may include a flexible plastic material. For example, the lower film LF may include polyethylene terephthalate.

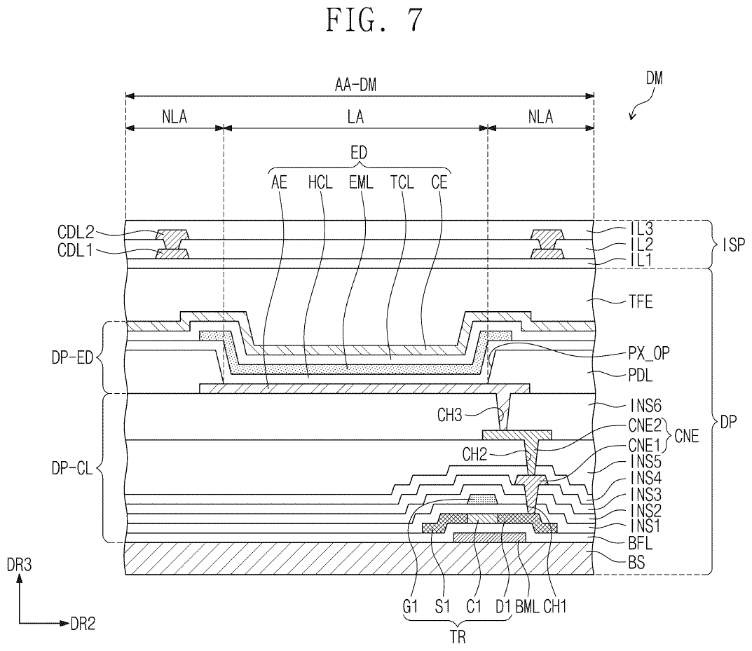

In an embodiment, the display module DM may include the display panel DP and an input-sensing layer ISP disposed on the display panel DP. The display panel DP may be a component that substantially generates an image. The display panel DP may be an emission-type display panel, and for example, the display panel DP may be an organic light-emitting display panel, an inorganic light-emitting display panel, a quantum-dot display panel, a micro-LED display panel, or a nano-LED display panel. The display panel DP may also be referred to as a display layer. The display panel DP may include a base layer BS (see FIG. 7), a circuit layer DP-CL (see FIG. 7), a display element layer DP-ED (see FIG. 7), and an encapsulation layer TFE (see FIG. 7) to be described later.

In an embodiment, the input-sensing layer ISP may detect an external input, convert the external input to a predetermined input signal, and provide the input signal to the display panel DP. For example, the input-sensing layer ISP may be a touch-sensing part that detects a touch. The input-sensing layer ISP may recognize a direct touch by a user, an indirect touch by a user, a direct touch by an object, an indirect touch by an object, or the like.

In an embodiment, the input-sensing layer ISP may detect at least any one of a position or strength (pressure) of a touch applied from the outside. The display panel DP may receive an input signal from the input-sensing layer ISP, and generate an image in correspondence to the input signal. For example, the input-sensing layer ISP may detect the external input in a capacitive manner. However, this is an example, and the operation manner of the input-sensing layer ISP is not limited to any one embodiment.

In an embodiment, the input-sensing layer ISP may be formed on the display panel DP through a continuous process. In this case, the input-sensing layer ISP may be directly disposed on the display panel DP. That is, there may be no separate adhesive member disposed between the input-sensing layer ISP and the display panel DP. In another embodiment, the input-sensing layer ISP may also be bonded to the display panel DP through an adhesive member. The adhesive member may include a general adhesive or gluing agent.

In this specification, one component directly disposed on another component means that there is no intervening component disposed between the one component and the other component. That is, one component directly disposed on another component means that the one component is in contact with the other component.

In an embodiment, the display device DD may include a third adhesive layer AP3 disposed between the lower film LF and the display panel DP, and a fourth adhesive layer AP4 disposed between the lower module LM and the lower film LF. The lower film LF and the display panel DP may be bonded to each other by the third adhesive layer AP3. The lower module LM and the lower film LF may be bonded to each other by the fourth adhesive layer AP4. The third adhesive layer AP3 and the fourth adhesive layer AP4 may each include a general adhesive or a gluing agent. For example, the third adhesive layer AP3 and the fourth adhesive layer AP4 may each include a general adhesive such as a pressure sensitive adhesive (PSA), an optically clear adhesive (OCA), and an optical clear resin (OCR), and the type is not limited to any one embodiment of the inventive concept. Unlike what is illustrated in the drawing, in another embodiment, at least one of the third adhesive layer AP3 or the fourth adhesive layer AP4 may be omitted.

In an embodiment, the lower module LM may include a supporting plate MP, a lower conductive layer CTL, and a lower supporting member BSM. The lower conductive layer CTL may be disposed between the lower supporting member BSM and the supporting plate MP.

In an embodiment, the supporting plate MP may be disposed under the display module DM. The supporting plate MP may include a metal material or a polymer material. For example, the supporting plate MP may be formed of the polymer material. Unlike this, the supporting plate MP may be formed by including stainless steel, aluminum, or an alloy thereof. A plurality of openings OP may be defined in the supporting plate MP. The plurality of openings OP may be formed in the folding region FA.

In an embodiment, the lower supporting member BSM may include a supporting member SPM and a filling part SAP. The supporting member SPM may be a component overlapping most of the region of the display module DM. The filling part SAP may be a component disposed on the outer side of the supporting member SPM and overlapping the outer part of the display module DM.

In an embodiment, the filling part SAP may be disposed on the outer part of a support layer SP and a cushion layer CP. The filling part SAP may be disposed between the supporting plate MP and the housing HAU (see FIG. 3). The filling part SAP may fill a space between the supporting plate MP and the housing HAU (see FIG. 3), and fix the supporting plate MP.

In an embodiment, the supporting member SPM may include the support layer SP, the cushion layer CP, and a shielding layer EMP. The support layer SP may be disposed under the supporting plate MP. The cushion layer CP may be disposed under the support layer SP. The shielding layer EMP may be disposed under the cushion layer CP. The composition of the supporting member SPM is not limited to what is illustrated in FIG. 4, and may vary according to the size or shape of the display device DD, or operational characteristics of the display device DD. For example, in another embodiment, a portion of the cushion layer CP and the shielding layer EMP may be omitted, or an additional component, other than the illustrated components, may further be included.

In an embodiment, the shielding layer EMP may be an electromagnetic wave shielding layer or a heat dissipation layer. In addition, the shielding layer EMP may function as a junction layer.

In an embodiment, the cushion layer CP may prevent compression and plastic deformation of the supporting plate MP due to external impact and power. The cushion layer CP may improve impact resistance of the display device DD. The cushion layer CP may include elastomer, etc. such as sponge, foam, or a urethane resin. In addition, the cushion layer CP may be formed by including at least one of acrylate-based polymer, urethane-based polymer, silicon-based polymer, or imide-based polymer. However, this is an example, and the invention is not limited thereto.

In an embodiment, the cushion layer CP may include a first sub-cushion layer CP1 and a second sub-cushion layer CP2 spaced apart from each other in a second direction DR2. The first sub-cushion layer CP1 and the second sub-cushion layer CP2 may be spaced apart from each other at a portion corresponding to the first folding axis FX1 (see FIG. 1B). Since the cushion layer CP is provided as the first sub-cushion layer CP1 and the second sub-cushion layer CP2 spaced apart from each other in the folding region FA, folding characteristics of the display device DD may be improved.

In an embodiment, the support layer SP may include a first sub-support layer SP1 and a second sub-support layer SP2 spaced apart from each other in the second direction DR2. The first sub-support layer SP1 and the second sub-support layer SP2 may be spaced apart from each other in a region corresponding to the first folding axis FX1 (see FIG. 1B). Since the support layer SP is provided as the first sub-support layer SP1 and the second sub-support layer SP2 spaced apart from each other in the folding region FA, folding characteristics of the display device DD may be improved.

In an embodiment, the support layer SP may include a polymer resin. The support layer SP may include any one among carbon fiber reinforced plastic (CFRP), glass fiber reinforced plastic (GFRP), and aramid fiber reinforced plastic (AFRP). The support layer SP including a polymer resin, such as the carbon fiber reinforced plastic, the glass fiber reinforced plastic, and the aramid fiber reinforced plastic, has a high modulus as well as it is light, so that it may be possible to improve the folding characteristics of the display device DD.

In an embodiment, the lower conductive layer CTL may be disposed on the support layer SP. The lower conductive layer CTL may include a first portion C-R1 overlapping the folding region FA, and a second portion C-R2 overlapping the non-folding regions NFA1 and NFA2. The first portion C-R1 and the second portion C-R2 may be integrally formed. A thickness TH1 of the first portion C-R1 may be smaller than a thickness TH2 of the second portion C-R2. Since the first portion C-R1, overlapping the folding region FA, is provided with a relatively smaller thickness, the folding characteristics of the display device DD may be improved.

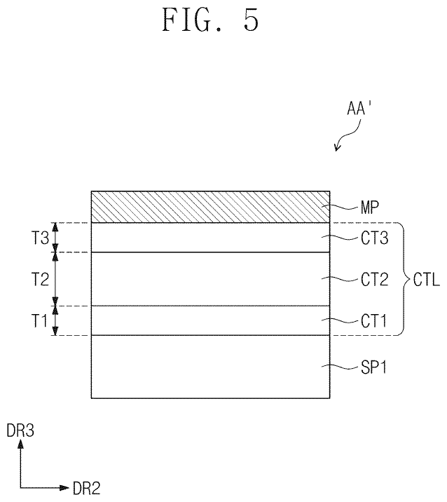

FIG. 5 is an enlarged cross-sectional view illustrating region AA′ of FIG. 4. In an embodiment and referring to FIG. 5, the lower conductive layer CTL may include a first metal layer CT1, a second metal layer CT2, and a third metal layer CT3 stacked in sequence. When a charged charge that impairs the operation of the display device DD occurs, the lower conductive layer CTL may discharge the generated charge.

In an embodiment, the first metal layer CT1 may be directly disposed on the support layer SP. The first metal layer CT1 may contain nickel (Ni) and vanadium (V). The content of vanadium may be about 1 at % to about 10 at % on the basis of about 100 at % of an atomic content of the first metal layer CT1. Compared to a metal layer containing nickel and not containing vanadium, the first metal layer CT1 containing nickel and vanadium may have a relatively large surface roughness. The average surface roughness of the lower conductive layer composed of the first metal layer containing nickel and not containing vanadium is about 300 nm to about 500 nm. In an embodiment, the average surface roughness of the lower conductive layer CTL including the first metal layer CT1, containing nickel and vanadium, may be about 1500 nm to about 3000 nm. The first metal layer CT1 containing nickel and vanadium may have improved bonding forces with the second metal layer CT2 disposed on the first metal layer CT1. In this specification, the average surface roughness may refer to a surface roughness of the lower conductive layer CTL, disposed on the support layer SP, which is measured by using an atomic force microscope (AFM).

In a typical display device, due to organic pollutants of a support layer containing a polymer resin, detachment of films occurred in a lower conductive layer disposed on the support layer in a high temperature and high humidity environment. In the high temperature and high humidity environment, the detachment of films occurred at an interface of a first metal layer and a second metal layer, thereby deteriorating reliability of the display device. In addition, the detachment of films occurred at an interface of the second metal layer and a third metal layer. The first metal layer did not contain vanadium and contained nickel. The high temperature and high humidity environment may refer to an environment with the temperature of about 80° C. or more, and with the relative humidity of about 80% or more.

Unlike this, since the first metal layer CT1, according to an embodiment, contains nickel and vanadium, the surface roughness may increase and the bonding force between the first metal layer CT1 and the second metal layer CT2 may be improved. The display device DD including the first metal layer CT1 containing nickel and vanadium may exhibit excellent reliability in the high temperature and high humidity environment.

In an embodiment, the first metal layer CT1 may further contain an element in the same group as that of vanadium. In this specification, “Group” means the group in the IUPAC periodic table. The first metal layer CT1 may further contain at least one of niobium (Nb), tantalum (Ta), or dubnium (Db). Niobium (Nb), tantalum (Ta), and dubnium (Db) are the elements in the same group as that of vanadium. The first metal layer CT1, further containing the element in the same group as that of vanadium, may have improved bonding forces with the second metal layer CT2 and exhibit excellent reliability in the high temperature and high humidity environment.

In an embodiment, the first metal layer CT1 may have a thickness T1 of about 60 nm to about 120 nm. In the first metal layer having a thickness less than about 60 nm, the bonding forces with the second metal layer may not be improved, and the detachment of films occurs in the high temperature and high humidity environment. In the first metal layer having a thickness greater than about 120 nm causes increase in the thickness of the display device. Unlike this, in an embodiment, the first metal layer CT1, having the thickness T1 of about 60 nm to about 120 nm, may have improved bonding forces with the second metal layer CT2 to thereby exhibit excellent reliability in the high temperature and high humidity environment, and so that it may be possible to maintain the thickness of the display device in a good level.

In an embodiment, the third metal layer CT3 may contain nickel (Ni). In addition, the third metal layer CT3 may contain vanadium (V). That is, the third metal layer CT3 may include nickel (Ni) and vanadium (V). The content of vanadium may be about 1 at % to about 10 at % on the basis of about 100 at % of an atomic content of the third metal layer CT3. The third metal layer CT3 containing nickel and vanadium may have a relatively large surface roughness. In an embodiment, the average surface roughness of the lower conductive layer CTL including the third metal layer CT3, containing nickel and vanadium, may be about 1500 nm to about 3000 nm. The third metal layer CT3 containing nickel and vanadium may have improved bonding forces with the second metal layer CT2 disposed adjacent to the third metal layer CT3.

In an embodiment, the third metal layer CT3 may have a thickness T3 of about 60 nm to about 120 nm. The third metal layer having a thickness less than about 60 nm may not have improved bonding forces with the second metal layer. In the third metal layer, having a thickness greater than about 120 nm causes increase in the thickness of the display device. Unlike this, in an embodiment, the third metal layer CT3, having the thickness T3 of about 60 nm to about 120 nm, may have improved bonding forces with the second metal layer CT2 to thereby exhibit excellent reliability in the high temperature and high humidity environment, so that it may be possible to maintain the thickness of the display device in a good level.

In an embodiment, the third metal layer CT3 may further include an element in the same group as that of vanadium. The third metal layer CT3 may further contain at least one of niobium (Nb), tantalum (Ta), or dubnium (Db). The third metal layer CT3, further containing the element in the same group as that of vanadium, may have improved bonding forces with the second metal layer CT2 and exhibit excellent reliability in the high temperature and high humidity environment.

In an embodiment, the second metal layer CT2 may contain silver (Ag). The second metal layer CT2 may be directly disposed between the first metal layer CT1 and the third metal layer CT3. The thickness T2 of the second metal layer CT2 may be larger than the thickness T1 of the first metal layer CT1 and the thickness T3 of the third metal layer CT3. For example, the thickness T2 of the second metal layer CT2 may be about 0.3 μm.

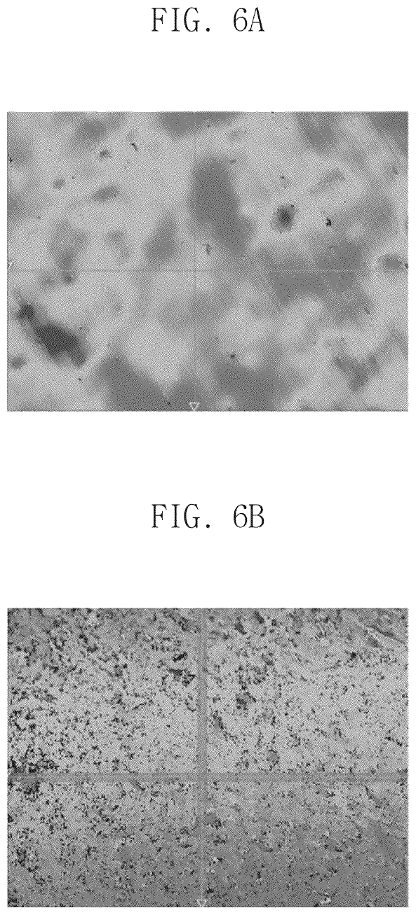

FIG. 6A is an image obtained from a microscope when measuring the surface roughness of a display device according to Comparative Example. FIG. 6B is an image obtained from a microscope when measuring the surface roughness of a display device of the Example, according to an embodiment. FIGS. 6A and 6B are images obtained from an atomic force microscope (AFM) when measuring the surface roughness using the atomic force microscope.

The display device of each of the Comparative Example and the Example includes first to third metal layers stacked in sequence on a support layer containing carbon fiber reinforced plastic, and the second metal layer contains silver. The difference between the display device of the Comparative Example and the display device of the Example is whether they contain vanadium or not. In the display device of the Comparative Example, each of the first metal layer and the third metal layer contains nickel, and does not contain vanadium. In the display device of the Example, according to an embodiment, each of the first metal layer and the third metal layer contains nickel and vanadium. In each of the first metal layer and the third metal layer, the content of vanadium is about 5.1 at % on the basis of about 100 at % of an atomic content.

In the display device of the Comparative Example in FIG. 6A, the average surface roughness of a lower conductive layer was measured to be about 307 nm. In the display device of the Example in FIG. 6B, the average surface roughness of a lower conductive layer was measured to be about 2694 nm. Referring to FIGS. 6A and 6B, it may be seen that the lower conductive layer, in the display device of the Example, has the average surface roughness much larger than that of the lower conductive layer in the display device of the Comparative Example. The display device of the Example, which is the display device, according to an embodiment, has the lower conductive layer containing vanadium, unlike the display device of the Comparative Example. Accordingly, in an embodiment, it may be seen that the lower conductive layer, composed of the first metal layer and the third metal layer containing nickel and vanadium, has a large average surface roughness of about 1500 nm to about 3000 nm. The display device, according to an embodiment, including the lower conductive layer with a large average surface roughness may exhibit excellent reliability in the high temperature and high humidity environment.

Table 1 below shows the result of reliability test of the display devices, according to the Comparative Example and the Example according to an embodiment, in the high temperature and high humidity environment. The display devices of the Comparative Example and the Example according to an embodiment are the same display devices of the Comparative Example and the Example according to an embodiment described with reference to FIGS. 6A and 6B.

The reliability of the display device of the Comparative Example was tested in the environment with the temperature of about 80° C. and the relative humidity of about 80% for about 240 hours, and the reliability of the display device of the Example according to an embodiment was tested in the environment with the temperature of about 85° C. and the relative humidity of about 85% for about 360 hours. In the display device of the Comparative Example, defects occurred in a relatively shorter time and in an environment with lower temperature and lower humidity than in the display device of the Example according to an embodiment, and thus the display device of the Comparative Example was not tested in the environment of the same temperature and the same humidity as the display device of the Example according to an embodiment.

In Table 1, “NG” refers to having detachment of films occurred at an interface between the metal layers, and “OK” refers to not having the defects such as the detachment of films. In particular, in the display device of the Comparative Example, the detachment of films occurred at an interface between the first metal layer containing nickel and the second metal layer containing silver.

TABLE 1

| | Comparative Example | Example |
|---|---|---|
| Test Environment | Temperature 80° C. | Temperature 85° C. |
| | Relative Humidity 80% | Relative Humidity 85% |
| Hours of Test (hr) | 240 | 360 |
| Reliability | NG | OK |

Referring to Table 1, it may be seen that in the display device of the Example according to an embodiment, the defects did not occur for a long time in the environment with the relatively high temperature and high humidity, compared to the display device of the Comparative Example. In the display device of the Comparative Example including the metal layer containing nickel and not containing vanadium, the detachment of films occurred at the interface between the metal layers.

The display device of the Example, which is the display device according to an embodiment, includes the first metal layer containing nickel and vanadium. In addition, the display device of the Example, which is the display device according to an embodiment, includes the third metal layer containing nickel and vanadium. It may be seen that the display device of the Example, including the metal layer containing nickel and vanadium, has improved bonding forces between the metal layers, thereby exhibiting excellent reliability. Accordingly, the display device according to an embodiment, including the metal layer containing nickel and vanadium, may have excellent reliability in the high temperature and high humidity environment.

FIG. 7 is a cross-sectional view of a display module DM, according to an embodiment. FIG. 7 may be a cross-sectional view particularly illustrating the composition of the display module DM illustrated in FIG. 4, according to an embodiment.

In an embodiment, the display panel DP may include a transistor TR and a light-emitting element ED. The transistor TR and the light-emitting element ED may be disposed on a base layer BS. One transistor TR is illustrated in FIG. 7, but substantially, the display panel DP may include a plurality of transistors and at least one capacitor for driving the light-emitting element ED.

In an embodiment, the base layer BS may provide a base surface on which a circuit layer DP-CL is disposed. The base layer BS may be a flexible substrate capable of bending, folding, rolling, etc. The base layer BS may be a glass substrate, a metal substrate, a polymer substrate, or the like. However, the invention is not limited thereto, and the base layer BS may include an inorganic layer, an organic layer, or a composite material layer.

In an embodiment, the base layer BS may include a single layer or multiple layers. For example, the base layer BS may include a first synthetic resin layer, a multi-layer or single-layer inorganic layer, a second synthetic resin layer disposed on the multi-layer or single-layer inorganic layer. The first synthetic resin layer and the second synthetic resin layer may each include a polyimide-based resin. In addition, the first synthetic resin layer and the second synthetic resin layer may each include at least one of an acrylate-based resin, a methacrylate-based resin, a polyisoprene-based resin, a vinyl-based resin, an epoxy-based resin, a urethane-based resin, a cellulose-based resin, a siloxane-based resin, a polyamide-based resin, or a perylene-based resin. In this specification, the term “˜˜-based” resin refers to including the functional group of “˜˜”.

In an embodiment, the circuit layer DP-CL may be disposed on the base layer BS. The circuit layer DP-CL may include a shielding electrode BML, a transistor TR, a connection electrode CNE, and a plurality of insulation layers BFL and INS1 to INS6. The plurality of insulation layers BFL and INS1 to INS6 may include a buffer layer BFL and first to sixth insulation layers INS1 to INS6, respectively. However, the stacked structure of the circuit layer DP-CL illustrated in FIG. 7 is an example, and, in another embodiment, the stacked structure of the circuit layer DP-CL may be changed according to the process of the circuit layer DP-CL, etc.

In an embodiment, the shielding electrode BML may be disposed on the base layer BS. The shielding electrode BML may overlap the transistor TR. The shielding electrode BML may block light incident from a lower part of the display panel DP to the transistor TR to thereby protect the transistor TR. The shielding electrode BML may include a conductive material. When a voltage is applied to the shielding electrode BML, the threshold voltage of the transistor TR, disposed on the shielding electrode BML, may be maintained. However, the invention is not limited thereto, and the shielding electrode BML may be a floating electrode. In another embodiment, unlike what is illustrated in the drawing, the shielding electrode BML may be omitted.

In an embodiment, the buffer layer BFL may be disposed on the base layer BS and cover the shielding electrode BML. The buffer layer BFL may include an inorganic layer. The buffer layer BFL may improve bonding forces between the base layer BS and a semiconductor pattern or a conductive pattern disposed on the buffer layer BFL.

In an embodiment, the transistor TR may include a source S1, a channel C1, a drain D1, and a gate G1. The source S1, the channel C1, and the drain D1 of the transistor TR may be formed from the semiconductor pattern. The semiconductor pattern of the transistor TR may include polysilicon, amorphous silicon, or metal oxide, and any material may be applied with no limitation as long as having semiconductor characteristics. The semiconductor pattern is not limited to any one embodiment.

In an embodiment, the semiconductor pattern may include a plurality of regions divided according to the level of conductivity. A region of the semiconductor pattern, which is doped with a dopant or where metal oxide is reduced, may have high conductivity, and may substantially serve as a source electrode and a drain electrode of the transistor TR. The region of the semiconductor pattern having high conductivity may correspond to the source S1 and the drain D1 of the transistor TR. A region of the semiconductor pattern, which is undoped or doped with low concentration or where metal oxide is unreduced, may have low conductivity, and the region may correspond to the channel C1 (or active) of the transistor TR.

In an embodiment, the first insulation layer INS1 may be disposed on the buffer layer BFL by covering the semiconductor pattern of the transistor TR. The gate G1 of the transistor TR may be disposed on the first insulation layer INS1. The gate G1 may overlap the channel C1 of the transistor TR. The gate G1 may function as a mask in a process of doping the semiconductor pattern of the transistor TR.

In an embodiment, the second insulation layer INS2 may be disposed on the first insulation layer INS1 by covering the gate G1. The third insulation layer INS3 may be disposed on the second insulation layer INS2.

In an embodiment, the connection electrode CNE may include a first connection electrode CNE1 and a second connection electrode CNE2 in order to electrically connect the transistor TR and the light-emitting element ED. However, the composition of the connection electrode CNE, electrically connecting the transistor TR and the light-emitting element ED, is not limited thereto, and one among the first and second connection electrodes CNE1 and CNE2 may be omitted or an additional connection electrode may further be included.

In an embodiment, the first connection electrode CNE1 may be disposed on the third insulation layer INS3. The first connection electrode CNE1 may be connected to the drain D1 through a first contact hole CH1 passing through the first to third insulation layers INS1 to INS3. The fourth insulation layer INS4 may be disposed on the third insulation layer INS3 by covering the first connection electrode CNE1. The fifth insulation layer INS5 may be disposed on the fourth insulation layer INS4.

In an embodiment, the second connection electrode CNE2 may be disposed on the fifth insulation layer INS5. The second connection electrode CNE2 may be connected to the first connection electrode CNE1 through a second contact hole CH2 passing through the fourth and fifth insulation layers INS4 and INS5, respectively. The sixth insulation layer INS6 may be disposed on the fifth insulation layer INS5 by covering the second connection electrode CNE2.

In an embodiment, the insulation layers INS1 to INS6 may each include an inorganic layer or an organic layer. For example, the inorganic layer may include at least one of aluminum oxide, titanium oxide, silicon oxide, silicon oxynitride, zirconium oxide, or hafnium oxide. The organic layer may include at least one of an acrylate-based resin, a methacrylate-based resin, a polyisoprene-based resin, a vinyl-based resin, an epoxy-based resin, a urethane-based resin, a cellulose-based resin, a siloxane-based resin, a polyamide-based resin, or a perylene-based resin.

In an embodiment, a display element layer DP-ED may be disposed on the circuit layer DP-CL. The display element layer DP-ED may include a pixel-defining film PDL and the light-emitting element ED. The light-emitting element ED may include a first electrode AE, a hole control layer HCL, a light-emitting layer EML, an electron control layer TCL, and a second electrode CE.

In an embodiment, the first electrode AE may be disposed on the sixth insulation layer INS6. The first electrode AE may be connected to the second connection electrode CNE2 through a third contact hole CH3 passing through the sixth insulation layer INS6. The first electrode AE may be electrically connected to the drain D1 of the transistor TR through the first and second connection electrodes CNE1 and CNE2.

In an embodiment, the first electrode AE may be formed of a metal material, a metal alloy, or a conductive compound. The first electrode AE may be an anode or cathode. However, the invention is not limited thereto. In addition, the first electrode AE may be a pixel electrode. The first electrode AE may be a transmissive electrode, a transflective electrode, or a reflective electrode. The first electrode AE may include at least one selected from Ag, Mg, Cu, Al, Pt, Pd, Au, Ni, Nd, Ir, Cr, Li, Ca, LiF, Mo, Ti, W, In, Sn, and Zn, a compound of at least two selected therefrom, a mixture of at least two selected therefrom, or an oxide thereof.

In an embodiment, if the first electrode AE is a transmissive electrode, the first electrode AE may include transparent metal oxide, for example, indium tin oxide (ITO), indium zinc oxide (IZO), zinc oxide (ZnO), indium tin zinc oxide (ITZO), etc. In an embodiment, if the first electrode AE is a transflective electrode or reflective electrode, the first electrode AE may include Ag, Mg, Cu, Al, Pt, Pd, Au, Ni, Nd, Ir, Cr, Li, Ca, LiF/Ca (a stacked structure of LiF and Ca), LiF/Al (a stacked structure of LiF and Al), Mo, Ti, W, or a compound or mixture thereof (for example, a mixture of Ag and Mg). In another embodiment, the first electrode AE may have a structure of multiple layers including a reflective film or transflective film formed of the above-described materials, and a transparent conductive film formed of indium tin oxide (ITO), indium zinc oxide (IZO), zinc oxide (ZnO), indium tin zinc oxide (ITZO), etc. For example, in an embodiment, the first electrode AE may have a three-layer structure of ITO/Ag/ITO, but an embodiment of the inventive concept is not limited thereto. In addition, the invention is not limited thereto, and in an embodiment, the first electrode AE may include the above-described metal materials, a combination of at least two metal materials selected from the above-described metal materials, an oxide of the above-described metal materials, or the like.

In an embodiment, a pixel-defining film PDL may be disposed on the sixth insulation layer INS6. A light-emitting opening PX_OP that exposes a portion of the first electrode AE may be defined in the pixel-defining film PDL. The portion of the first electrode AE exposed by the light-emitting opening PX_OP may be defined as a light-emitting region LA. A region where the pixel-defining film PDL is disposed may correspond to a light-blocking region NLA. The light-blocking region NLA may surround the light-emitting region LA in a display region AA-DM.

In an embodiment, the hole control layer HCL may be disposed on the first electrode AE and the pixel-defining film PDL. The hole control layer HCL may be provided as a common layer overlapping the light-emitting region LA and the light-blocking region NLA. The hole control layer HCL may include at least one of a hole transport layer, a hole injection layer, or an electron-blocking layer. The hole control layer HCL may include a known hole injection material and/or a known hole transport material.

In an embodiment, the light-emitting layer EML may be disposed on the hole control layer HCL. The light-emitting layer EML may be disposed in a region corresponding to the light-emitting opening PX_OP. Unlike this, the light-emitting layer EML may also be provided as a common layer. The light-emitting layer EML may include an organic light-emitting material and/or an inorganic light-emitting material. The light-emitting layer EML may emit light of any one color among red, green, and blue.

In an embodiment, the electron control layer TCL may be disposed on the light-emitting layer EML. The electron control layer TCL may be provided as a common layer overlapping the light-emitting region LA and the light-blocking region NLA. The electron control layer TCL may include at least one of an electron transport layer, an electron injection layer, or a hole-blocking layer. The electron control layer TCL may include a known electron injection material and/or a known electron transport material.

In an embodiment, the second electrode CE may be disposed on the electron control layer TCL. The second electrode CE may be provided as a common layer overlapping the light-emitting region LA and the light-blocking region NLA. The second electrode CE may be a common electrode. The second electrode CE may be a cathode or an anode, but the invention is not limited thereto. For example, in an embodiment, when the first electrode AE is the anode, the second electrode CE may be the cathode, and when the first electrode AE is the cathode, the second electrode CE may be the anode.

In an embodiment, the second electrode CE may be a transmissive electrode, a transflective electrode, or a reflective electrode. If the second electrode CE is the transmissive electrode, the second electrode CE may be formed of transparent metal oxide, for example, indium tin oxide (ITO), indium zinc oxide (IZO), zinc oxide (ZnO), indium tin zinc oxide (ITZO), etc.

In an embodiment, when the second electrode CE is a transflective electrode or reflective electrode, the second electrode CE may include Ag, Mg, Cu, Al, Pt, Pd, Au, Ni, Nd, Ir, Cr, Li, Ca, LiF/Ca, LiF/Al, Mo, Ti, Yb, W, or a compound or mixture thereof (for example, AgMg, AgYb, or MgYb). In another embodiment, the second electrode CE may have a structure of multiple layers including a reflective film or transflective film formed of the above-mentioned materials, and a transparent conductive film formed of indium tin oxide (ITO), indium zinc oxide (IZO), zinc oxide (ZnO), indium tin zinc oxide (ITZO), etc. For example, in an embodiment, the second electrode CE may include the above-described metal materials, a combination of at least two metal materials selected from the above-described metal materials, an oxide of the above-described metal materials, or the like.

In an embodiment, an encapsulation layer TFE may be disposed on the display element layer DP-ED. The encapsulation layer TFE may be disposed on the second electrode CE to cover the light-emitting element ED. The encapsulation layer TFE may include a plurality of thin-films. For example, the encapsulation layer TFE may include inorganic films disposed on the second electrode CE and an organic film disposed between the inorganic films. The inorganic film may protect the light-emitting element ED from moisture/oxygen, and the organic film may protect the light-emitting element ED from foreign substances such as dust particles.

In an embodiment, an input-sensing layer ISP may include a first sensing insulation layer IL1, a second sensing insulation layer IL2, and a third sensing insulation layer IL3. The input-sensing layer ISP may include at least one conductive layer disposed on the sensing insulation layers. The input-sensing layer ISP may include a first conductive layer CDL1 and a second conductive layer CDL2.

In an embodiment, the first sensing insulation layer IL1 may be disposed on the encapsulation layer TFE. The first sensing insulation layer IL1 may include at least one inorganic insulation layer. The first sensing insulation layer IL1 may be in contact with the encapsulation layer TFE. Unlike this, in another embodiment, the first sensing insulation layer IL1 may also be omitted, and in this case, the first conductive layer CDL1 may be in contact with the encapsulation layer TFE.

In an embodiment, the first conductive layer CDL1 may be disposed on the first sensing insulation layer IL1. The first conductive layer CDL1 may include a plurality of first conductive patterns. The plurality of first conductive patterns may be disposed on the first sensing insulation layer IL1. A second sensing insulation layer IL2 may be disposed on the first sensing insulation layer IL1 to cover at least a portion of the first conductive layer CDL1.

In an embodiment, the second conductive layer CDL2 may be disposed on the second sensing insulation layer IL2. The second conductive layer CDL2 may include a plurality of second conductive patterns. The plurality of second conductive patterns may be disposed on the second sensing insulation layer IL2. The plurality of second conductive patterns may be respectively connected to the plurality of first conductive patterns through contact holes formed in the second sensing insulation layer IL2.

In an embodiment, the plurality of first conductive patterns of the first conductive layer CDL1 and the plurality of second conductive patterns of the second conductive layer CDL2 may each be disposed in correspondence to the light-blocking region NLA. The plurality of first conductive patterns of the first conductive layer CDL1 and the plurality of second conductive patterns of the second conductive layer CDL2 may each correspond to a mesh pattern.

In an embodiment, the third sensing insulation layer IL3 may be disposed on the second sensing insulation layer IL2, and cover the second conductive layer CDL2. The second sensing insulation layer IL2 and the third sensing insulation layer IL3 may each include an inorganic insulation layer or an organic insulation layer.

In an embodiment, the first conductive layer CDL1 and the second conductive layer CDL2 may each have a single-layer structure, or may have a structure of multiple layers stacked along a third direction DR3. The single-layer conductive layer CDL1 or CDL2 may include a metal layer or a transparent conductive layer. The metal layer may include molybdenum, silver, titanium, copper, aluminum, or an alloy thereof. The transparent conductive layer may include transparent conductive oxide such as indium tin oxide (ITO), indium zinc oxide (IZO), zinc oxide (ZnO), or indium zinc tin oxide (IZTO). In addition, the transparent conductive layer may include conductive polymer such as PEDOT, metal nanowires, graphene, etc.

In an embodiment, the multi-layer conductive layer CDL1 or CDL2 may include metal layers. The metal layers may have a three-layer structure, for example, of titanium (Ti)/aluminum (Al)/titanium (Ti). The multi-layer conductive layer CDL1 or CDL2 may include at least one metal layer and at least one transparent conductive layer.

In an embodiment, a display device may include a support layer containing a polymer resin, a conductive layer disposed on the support layer, and a display panel disposed on the conductive layer. The conductive layer may include first to third metal layers stacked in sequence. The first metal layer may contain nickel and vanadium, and may thus have improved bonding forces with the second metal layer in a high temperature and high humidity environment. Accordingly, the display device, according to an embodiment, may exhibit excellent reliability in the high temperature and high humidity environment.

A display device, according to an embodiment, may include a lower conductive layer containing nickel and vanadium, and may thus exhibit excellent reliability in a high temperature and high humidity environment.

Although the embodiments of the invention have been described, it is understood that the invention should not be limited to these embodiments but various changes and modifications can be made by one ordinary skilled in the art within the spirit and scope of the invention. Therefore, the technical scope of the invention should not be limited to the contents described in the detailed description of the specification. Moreover, embodiments or parts of the embodiments may be combined in whole or in part without departing from the scope of the invention.

What is claimed is:

1. A display device divided into a deformable part which is foldable or rollable and a non-deformable part disposed adjacent to the deformable part, the display device comprising:
a support layer including a polymer resin;
a lower conductive layer disposed on the support layer and including a first metal layer, a second metal layer, and a third metal layer stacked in sequence; and
a display panel disposed on the lower conductive layer,
wherein the first metal layer contains nickel (Ni) and vanadium (V), the second metal layer contains silver (Ag), and the third metal layer contains nickel (Ni).

2. The display device of claim 1, wherein the first metal layer is directly disposed on the support layer.

3. The display device of claim 1, wherein a content of the vanadium is about 1 at % to about 10 at % on the basis of about 100 at % of an atomic content of the first metal layer.

4. The display device of claim 1, wherein the first metal layer further comprises at least one of niobium (Nb), tantalum (Ta), or dubnium (Db).

5. The display device of claim 1, wherein the lower conductive layer has an average surface roughness of about 1500 nm to about 3000 nm.

6. The display device of claim 1, wherein the first metal layer has a thickness of about 60 nm to about 120 nm.

7. The display device of claim 1, wherein the third metal layer further comprises vanadium.

8. The display device of claim 1, wherein the third metal layer has a thickness of about 60 nm to about 120 nm.

9. The display device of claim 1, wherein the third metal layer further comprises at least one of niobium (Nb), tantalum (Ta), or dubnium (Db).

10. The display device of claim 1, wherein the support layer comprises any one among carbon fiber reinforced plastic (CFRP), glass fiber reinforced plastic (GFRP), and aramid fiber reinforced plastic (AFRP).

11. The display device of claim 1, wherein a thickness of the second metal layer is larger than a thickness of the first metal layer and a thickness of the third metal layer.

12. The display device of claim 1, wherein the second metal layer is directly disposed between the first metal layer and the third metal layer.

13. A display device divided into a deformable part which is foldable or rollable and a non-deformable part disposed adjacent to the deformable part, the display device comprising:
a support layer including a polymer resin;
a lower conductive layer disposed on the support layer and including a first metal layer, a second metal layer, and a third metal layer stacked in sequence; and
a display panel disposed on the lower conductive layer,
wherein each of the first metal layer and the third metal layer contains nickel (Ni) and vanadium (V), and
wherein a content of the vanadium is about 1 at % to about 10 at % on the basis of about 100 at % of an atomic content of each of the first metal layer and the third metal layer.

14. The display device of claim 13, wherein the second metal layer comprises silver (Ag).

15. The display device of claim 13, wherein a thickness of the second metal layer is larger than a thickness of the first metal layer and a thickness of the third metal layer.

16. The display device of claim 13, wherein each of the first metal layer and the third metal layer further comprises at least one of niobium (Nb), tantalum (Ta), or dubnium (Db).

17. The display device of claim 13, wherein the lower conductive layer has an average surface roughness of about 1500 nm to about 3000 nm.

18. The display device of claim 13, wherein each of the first metal layer and the third metal layer has a thickness of about 60 nm to about 120 nm.

19. The display device of claim 13, wherein the first metal layer is directly disposed on the support layer.

20. The display device of claim 13, wherein the support layer comprises any one among carbon fiber reinforced plastic (CFRP), glass fiber reinforced plastic (GFRP), and aramid fiber reinforced plastic (AFRP).
